(19) United States
(12) Patent Application Publication
(10) Pub. No.: US 2026/0009429 A1
(43) Pub. Date: Jan. 8, 2026

(54) SLIP GEAR ASSEMBLY FOR SNOWMOBILE

(71) Applicant: Textron Inc., Providence, RI (US)

(72) Inventor: Samuel Sandoz, Providence, RI (US)

(21) Appl. No.: 18/763,549

(22) Filed: Jul. 3, 2024

(51) Int. Cl. F16D 7/02; B62M 9/02; B62M 27/02

(52) U.S. Cl. CPC F16D 7/027; B62M 9/02; B62M 27/02

(57) ABSTRACT

A gear assembly for transferring power between a prime mover and a tractive element of a snowmobile includes a first body configured to couple to the prime mover, a second body configured to couple to the tractive element, a first pressure plate coupled to the first body, and a second pressure plate coupled to the second body. The first pressure plate includes a first friction surface. The second pressure plate includes a second friction surface. The second friction surface forms a friction torque with the first friction surface such that the second pressure plate is coupled to the first pressure plate when a torque between the first pressure plate and the second pressure plate is less the friction torque and the second pressure plate and the first pressure plate separately rotate when the torque is greater than to the friction torque

### BACKGROUND

The present application relates to a drive system of a vehicle. More specifically, the present application relates to belt drive system of a snowmobile.

### SUMMARY

One embodiment relates to a gear assembly for transferring power between a prime mover and a tractive element of a snowmobile. The slip gear assembly includes a first body configured to couple to a sprocket of the snowmobile coupled to the prime mover, a second body configured to couple to a shaft of the snowmobile coupled to the tractive element, a first pressure plate coupled to the first body, and a second pressure plate coupled to the second body. The first body, the second body, the first pressure plate, and the second pressure plate are configured to rotate about an axis. The first pressure plate includes a first friction surface positioned on at least one side of the first pressure plate. The second pressure plate includes a second friction surface positioned on at least one side of the second pressure plate. The second friction surface forms a friction torque between the second friction surface and the first friction surface such that the second pressure plate is coupled to the first pressure plate when a torque between the first pressure plate and the second pressure plate is less the friction torque and the second pressure plate and the first pressure plate separately rotate when the torque between the first pressure plate and the second pressure plate is greater than or equal to the friction torque

Another embodiment relates to a vehicle. The vehicle includes a frame, a tractive assembly coupled to the frame, a prime mover configured to provide power to the tractive assembly to drive the tractive assembly, and a transmission assembly configured to transfer the power from the prime mover to the tractive assembly. The tractive assembly is configured to propel the vehicle. The transmission assembly includes a slip gear assembly configured to receive the power from the prime mover and provide the power to the tractive assembly. The slip gear assembly includes a first body configured to receive the power from the prime mover, a second body configured to provide the power to the tractive assembly, a first pressure plate coupled to the first body, and a second pressure plate coupled to the second body. The second pressure plate contacts the first pressure plate to form a friction torque between the second pressure plate and the first pressure plate such that the first pressure plate is coupled to the second pressure plate when a torque between the first pressure plate and the second pressure plate is less than the friction torque to allow for the power to be transferred from the prime mover to the tractive assembly and the second pressure plate and the first pressure plate separately rotate when the torque between the first pressure plate and the second pressure plate is greater than or equal to the friction torque to prevent the power from being transferred from the prime mover to the tractive assembly.

Still another embodiment relates to a transmission assembly for transmitting power between a prime mover and a tractive assembly of a snowmobile. the transmission assembly includes a belt assembly configured to receive the power from the prime mover, a shaft configured to provide the power to the tractive assembly, and a slip gear assembly configured to transfer the power from the belt assembly to the shaft. The belt assembly includes a first sprocket configured to receive the power from the prime mover, a second sprocket, and a belt coupled to the first sprocket and the second sprocket. The belt is configured to transfer the power between the first sprocket and the second sprocket. The slip gear assembly includes a first body removably coupled to the second sprocket and a second body removably coupled to the shaft. The second body is coupled to the first body when a torque between the first body and the second body is less than a torque threshold and the second body and the first body separately rotate when the torque between the first body and the second body is greater than or equal to the torque threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a schematic block diagram of the vehicle of FIG. 1, according to an exemplary embodiment.

FIG. 3 is a side view of a transmission assembly of the vehicle of FIG. 1, according to an exemplary embodiment.

FIG. 4 is a perspective view of the transmission assembly of FIG. 3, according to an exemplary embodiment.

FIG. 5 is a detailed perspective view of a portion of the transmission assembly of FIG. 3, according to an exemplary embodiment.

FIG. 6 is a detailed side view of a portion of the transmission assembly of FIG. 5, according to an exemplary embodiment.

FIG. 7 is a cross-section view of a slip gear assembly of the transmission assembly of FIG. 6, according to an exemplary embodiment.

FIG. 8 is an exploded view of a portion of the slip gear assembly of FIG. 7, according to an exemplary embodiment.

FIG. 9 is an exploded view of the slip gear assembly of FIG. 7, according to an exemplary embodiment.

FIG. 10 is an exploded cross-section view of a portion of the slip gear assembly of FIG. 7, according to an exemplary embodiment.

FIG. 11 is a detailed view of a portion of the slip gear assembly of FIG. 7, according to an exemplary embodiment.

FIG. 12 is another detailed view of a portion of the slip gear assembly of FIG. 7, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle of the present disclosure includes a transmission configured to facilitate selectively transferring torque between a tractive assembly of the vehicle and a prime mover of the vehicle configured to provide power to the tractive assembly to drive the tractive assembly. The transmission includes a slip gear assembly configured to transfer torque between the prime mover and the tractive assembly when the torque is below a torque threshold and prevent the transfer of the torque between the prime mover and the tractive assembly when the torque is greater than or equal to the torque threshold. The slip gear assembly may include a first body or a first body assembly configured to receive the power from the prime mover, a second body or a second body assembly configured to provide the power from the prime mover to the tractive assembly, a first pressure plate coupled to the first body or the first body assembly and configured to rotate with the first body or the first body assembly, and a second pressure plate coupled to the second body or the second body assembly and configured to rotate with the second body or the second body assembly. The first pressure plate includes a first friction surface configured to selectively couple with a second friction surface of the second pressure plate through a friction toque between the first friction surface and the second friction surface. When the torque between the first pressure plate and the second pressure plate is below the torque threshold, the friction torque between the first friction surface and the second friction surface couples the first pressure plate to the second pressure plate and the torque is transferred through the slip gear assembly. When the torque between the first pressure plate and the second pressure plate is above the torque threshold, the friction torque between the first friction surface and the second friction surface is overcome, the first pressure plate rotates relative to the second pressure plate, and the torque is not transferred through the slip gear assembly. The slip gear assembly may be configured as a modular slip gear assembly that may be changed out for another slip gear assembly when performance of the slip gear assembly is diminished. The slip gear assembly may be configured as a dry slip gear assembly that does not include a fluid lubricant.

### Overall Vehicle

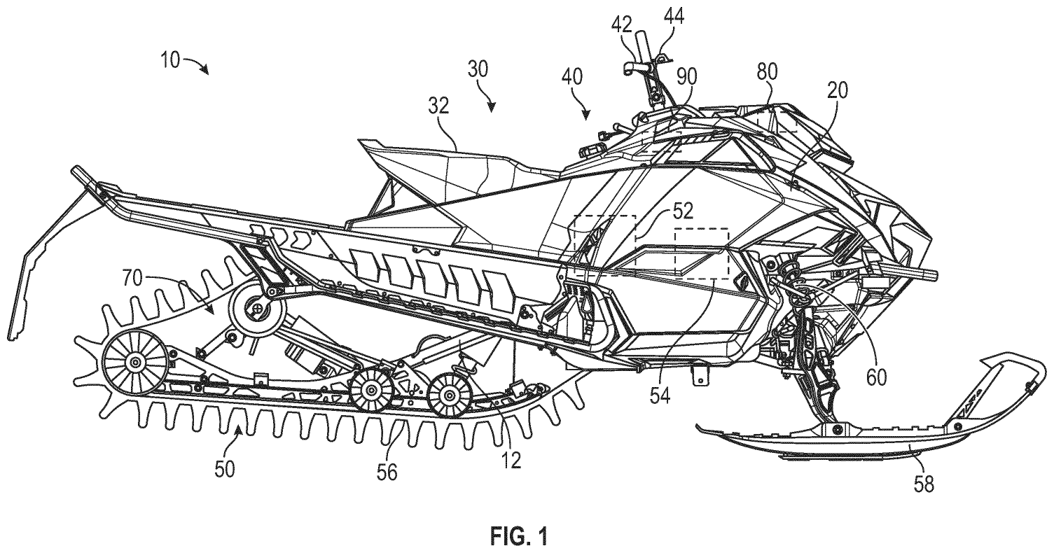

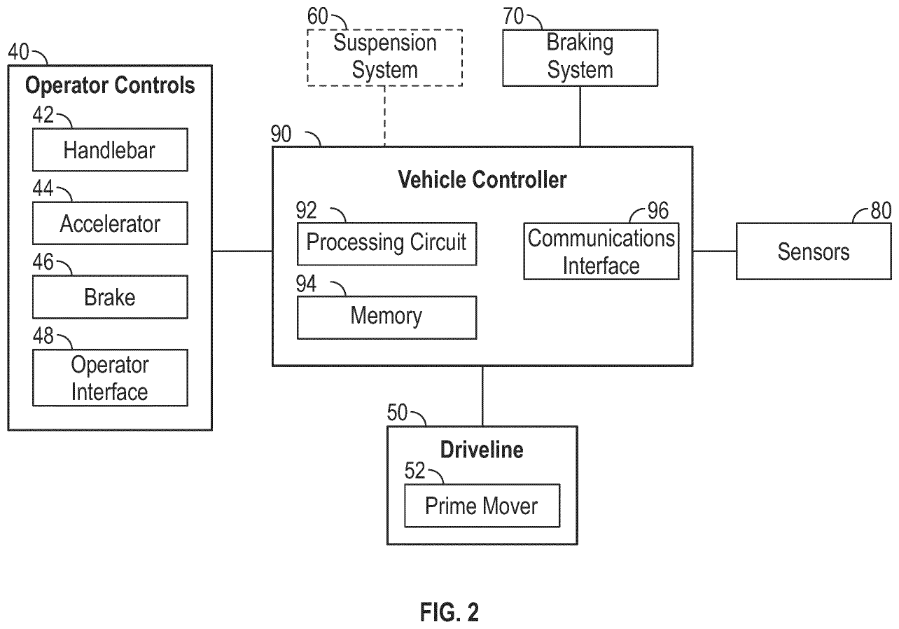

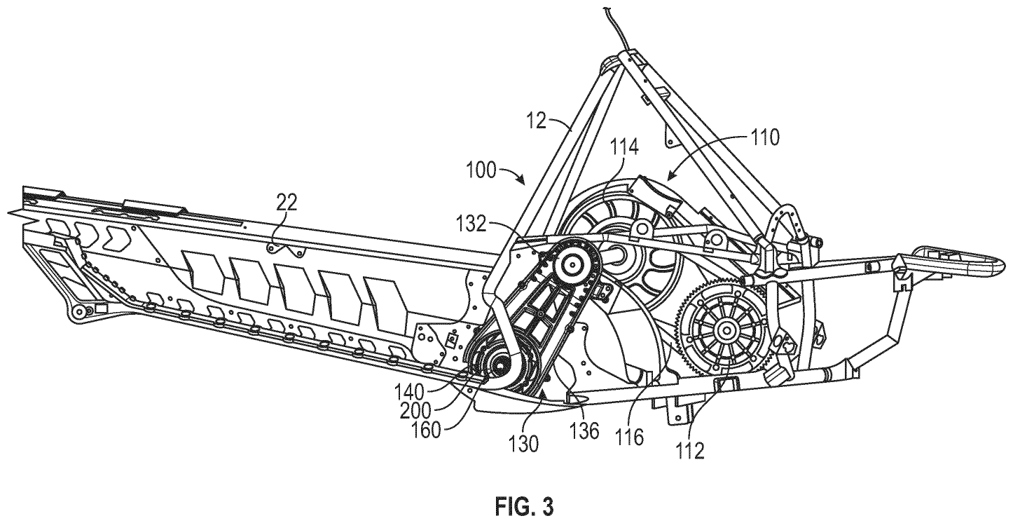

As shown in FIGS. 1 and 2, a machine or vehicle, shown as vehicle 10, includes a chassis, shown as frame 12, a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 80; and a vehicle control system, shown as vehicle controller 90, coupled to the operator controls 40, the driveline 50, the suspension system 60, the braking system 70, and the sensors 80. In some embodiments, the vehicle 10 includes more or fewer components. As shown in FIG. 3, the body 20 include a tunnel assembly, shown as tunnel 22, configured to receive at least a portion of the driveline 50 to prevent the portion of the driveline 50 from transferring material (e.g., snow, rocks, etc.) into the occupant seating area 30.

According to an exemplary embodiment, the vehicle 10 is a tracked, winter-focused off-road machine or vehicle configured to be operated on a snowy and/or icy surface (e.g., operated in snow, on ice, etc.). In some embodiments, the tracked, winter-focused off-road machine or vehicle is a lightweight or recreational machine or vehicle such as a snowmobile, a snow bike, a snow scooter, a snow all-terrain vehicle (“ATV”), a snow utility task vehicle (“UTV”), a snow plow machine, and/or another type of lightweight or recreational machine configured to be operated on a snowy and/or icy surface. In other embodiments, the tracked, snow-focused off-road machine or vehicle is a large machine or vehicle such as a snowcat, a snow groomer, a snow plow machine, a tractor, and/or another type of large machine or vehicle configured to be operated on a snowy and/or icy surface. In still other embodiments, the vehicle 10 is a non-tracked, off-road machine or vehicle such as an ATV, a UTV, a dirt bike, and/or another type of non-tracked, off-road machine or vehicle.

According to the exemplary embodiment shown in FIG. 1, the occupant seating area 30 includes a first seat, shown as operator seat 32, configured to support an operator of the vehicle 10. In some embodiments, the occupant seating area 30 includes a double seat configured to support the operator of the vehicle 10 and a passenger of the vehicle 10 behind the operator, or a triple seat configured to support the operator of the vehicle 10 and two passengers of the vehicle 10 behind the operator. In some embodiments, the occupant seating area 30 includes a second seat positioned rearward of or to the side of the operator seat 32. The second seat may be configured to support passengers of the vehicle 10. In some embodiments, in addition to or in place of the second seat, the vehicle 10 includes one or more rear accessories. Such rear accessories may include a ski rack, a bed, a cargo body (e.g., for a storage, etc.), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a handlebar, a steering column, a handlebar assembly, joystick(s), a steering wheel, etc.), shown as handlebar 42, an accelerator interface (e.g., a pedal, a throttle, a throttle lever, etc.), shown as accelerator 44, a braking interface (e.g., a brake pedal, a brake lever, a brake arm, etc.), shown as brake interface 46, and one or more additional interfaces (e.g., a light control interface, an operational mode interface, etc.), shown as operator interfaces 48. The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., tracks, treads, axles, differentials, etc.), shown as rear tractive assembly 56, and a second tractive assembly (e.g., skis, runners, slides, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes a rear tractive element that is configured as a track and the front tractive assembly 58 includes front tractive elements configured as skis. For example, the rear tractive element may be configured as a track configured to engage a snowy surface in order to drive the vehicle 10 and the front skis may be configured to slide or glide along the snowy surface. In some embodiments, the rear tractive assembly 56 includes a plurality of the rear tractive elements configured as tracks. In some embodiments, the rear tractive assembly 56 is at least partially disposed within the tunnel 22. By way of example, a top portion of the rear tractive assembly 56 may be disposed within the tunnel 22 to prevent the rear tractive assembly 56 from transferring snow into the occupant seating area 30. In some embodiments, the front tractive assembly 58 includes front tractive elements that are configured as tracks. In other embodiments, the front tractive assembly 58 and the rear tractive assembly 56 include tractive elements that are configured as wheels.

According to an exemplary embodiment, the prime mover 52 is configured to provide power to drive the rear tractive assembly 56 (e.g., to provide rear-track drive, etc.). In some embodiments, the prime mover 52 is configured to provide power to drive the rear tractive assembly 56 and/or the front tractive assembly 58 (e.g., to provide front-track drive, to provide all-track drive, etc.). In some embodiments, the driveline 50 includes a transmission device (e.g., a gearbox, a continuous variable transmission (“CVT”), the transmission assembly 100, etc.) positioned between (a) the prime mover 52 and (b) the rear tractive assembly 56. In a non-track arrangement, the rear tractive assembly 56 may include a drive shaft, a differential, and/or an axle. In such non-track arrangement, the rear tractive assembly 56 includes two axles or a tandem axle arrangement. According to an exemplary embodiment, the front tractive assembly 58 is steerable (e.g., using the handlebar 42). In some embodiments, the rear tractive assembly 56 is additionally or alternatively steerable. In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first of the prime movers 52 that drives a first one of the rear tractive elements and a second of the prime movers 52 that drives a second one of the rear tractive elements when the rear tractive assembly 56 includes two rear tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

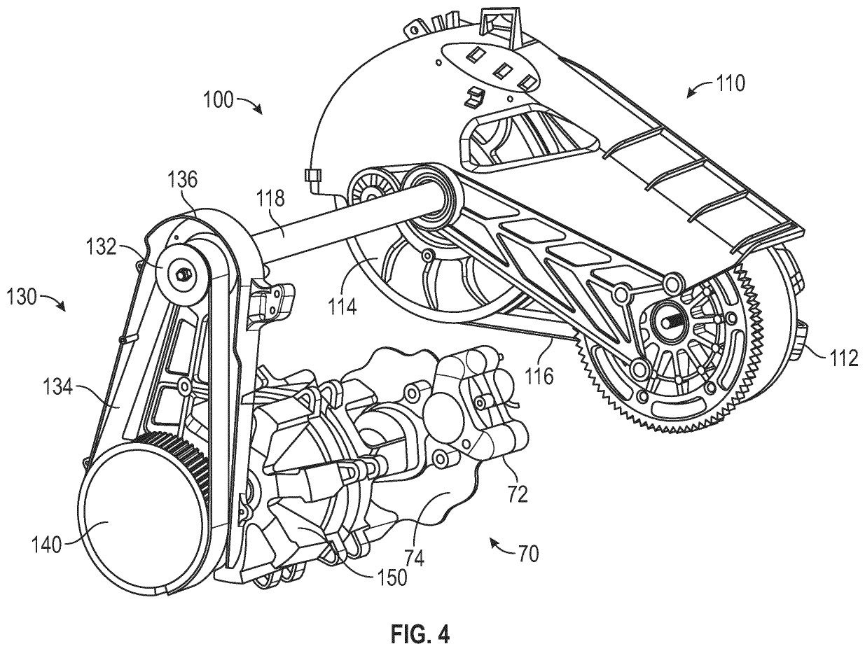

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include one or more rear braking components positioned to facilitate braking one or more components of the rear tractive assembly 56 (e.g., the rear axle, the rear tractive elements, etc.). In some embodiments (e.g., embodiments with two rear tractive elements), the one or more rear braking components include two rear braking components, one positioned to facilitate braking each of the rear tractive elements. According to the exemplary embodiment shown in FIG. 4, the braking system 70 includes a brake assembly (e.g., a braking element, etc.), shown as brake 72, coupled to the frame 12 and/or the body 20, and a brake disk, shown as brake disk 74, coupled to a rotating component of the driveline 50. The brake 72 is configured to selectively engage the brake disk 74 to facilitate braking the rotating component of the driveline 50 (e.g., via friction, etc.).

The sensors 80 may include various sensors positioned about the vehicle 10 to acquire vehicle information or vehicle data regarding operation of the vehicle 10 and/or the location thereof. By way of example, the sensors 80 may include an accelerometer, a gyroscope, a compass, a position sensor (e.g., a GPS sensor, etc.), suspension sensor(s), wheel/track sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 80 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 90 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 90 includes a processing circuit 92, a memory 94, and a communications interface 96. The processing circuit 92 may include an ASIC, one or more FPGAs, a DSP, circuits containing one or more processing components, circuitry for supporting a microprocessor, a group of processing components, or other suitable electronic processing components. In some embodiments, the processing circuit 92 is configured to execute computer code stored in the memory 94 to facilitate the activities described herein. The memory 94 may be any volatile or non-volatile or non-transitory computer-readable storage medium capable of storing data or computer code relating to the activities described herein. According to an exemplary embodiment, the memory 94 includes computer code modules (e.g., executable code, object code, source code, script code, machine code, etc.) configured for execution by the processing circuit 92. In some embodiments, the vehicle controller 90 may represent a collection of processing devices. In such cases, the processing circuit 92 represents the collective processors of the devices, and the memory 94 represents the collective storage devices of the devices.

In one embodiment, the vehicle controller 90 is configured to selectively engage, selectively disengage, control, or otherwise communicate with components of the vehicle 10 (e.g., via the communications interface 96, a controller area network (“CAN”) bus, etc.). According to an exemplary embodiment, the vehicle controller 90 is coupled to (e.g., communicably coupled to) components of the operator controls 40 (e.g., the handlebar 42, the accelerator 44, the brake interface 46, the operator interface 48, etc.), components of the driveline 50 (e.g., the prime mover 52), components of the braking system 70, and the sensors 80. By way of example, the vehicle controller 90 may send and receive signals (e.g., control signals, location signals, etc.) with the components of the operator controls 40, the components of the driveline 50, the components of the braking system 70, the sensors 80, and/or remote systems or devices (via the communications interface 96 as described in greater detail herein).

### Transmission Assembly

As shown in FIGS. 3 and 4, the driveline 50 includes a transmission (e.g., a drivetrain, a transmission system, etc.), shown as transmission assembly 100, coupled between (i) the prime mover 52 and (ii) the front tractive assembly 58 and/or the rear tractive assembly 56. The transmission assembly 100 is configured to transfer power (e.g., motive power, torque, etc.) between the prime mover 52 and the rear tractive assembly 56. In some embodiments, the transmission assembly 100 is additionally or alternatively configured to transfer power between the prime mover 52 and the front tractive assembly 58 (e.g., in embodiments where the front tractive assembly 58 includes tracks or wheels). According to an exemplary embodiment, the transmission assembly 100 is configured to manipulate (e.g., reduce, increase, etc.) an input (e.g., a torque, speed, power, etc.) provided by the prime mover 52 to the front tractive assembly 58 and/or the rear tractive assembly 56 when the transmission assembly 100 transfers the power between (i) the prime mover 52 and (ii) the front tractive assembly 58 and/or the rear tractive assembly 56. By way of example, when the vehicle 10 performs a jump (e.g., disengages from the ground, etc.), the vehicle 10 may land while the prime mover 52 is providing power to the front tractive assembly 58 and/or the rear tractive assembly 56 via the transmission assembly 100. When landing, the front tractive assembly 58 and/or the rear tractive assembly 56 may apply a load spike (e.g., a sudden increase in load, etc.) on the transmission assembly 100 due to the front tractive assembly 58 and/or the rear tractive assembly 56 engaging the ground. The load spike may be above a load rating (e.g., a toque limit, a torque rating, etc.) of the prime mover 52 and/or components of the transmission assembly 100. As a result, the transmission assembly 100 limits the load transferred between the between (i) the prime mover 52 and (ii) the front tractive assembly 58 and/or the rear tractive assembly 56 based on a load threshold that is less than or equal to the load rating of the prime mover 52 and/or components of the transmission assembly 100 to protect the prime mover 52 and/or components of the transmission assembly 100 from the load spike.

As shown in FIGS. 3 and 4, the transmission assembly 100 includes a first or transmission input assembly (e.g., a continuous variable transmission clutch, etc.), shown as clutch assembly 110, coupled to the prime mover 52 and configured to receive the power provided by the prime mover 52; a second or transmission output assembly (e.g., torque transfer system, etc.), shown as belt assembly 130, coupled to the clutch assembly 110 and configured to receive power from the clutch assembly 110; a third or tractive output assembly (e.g., a drive cog, a drive gear, a drive wheel, a track sprocket, etc.), shown as drive sprocket 150, configured to engage the rear tractive assembly 56 and provide power to the rear tractive assembly 56 to drive the rear tractive assembly 56; a shaft (e.g., a torque shaft, etc.), shown as drive shaft 160, coupled to the drive sprocket 150 and configured to provide power to the drive sprocket 150; and a slip gear (e.g., modular slip gear, modular slip gear assembly, etc.), shown as slip gear assembly 200, (a) coupled to the belt assembly 130, (b) coupled to the drive shaft 160, and (c) configured to selectively transfer power between the belt assembly 130 and the drive shaft 160. By way of example, the prime mover 52 may generate power for driving the rear tractive assembly 56 and provide the power to the clutch assembly 110, the clutch assembly 110 may provide the power to the belt assembly 130, the belt assembly 130 may provide the power to the drive shaft 160 through the slip gear assembly 200, and the drive shaft 160 may provide the power to the drive sprocket 150 which uses the power to drive the rear tractive assembly 56. In other embodiments, the transmission assembly 100 includes a different configuration of components configured to transfer the power provided by the prime mover 52 to the front tractive assembly 58 and/or the rear tractive assembly 56. By way of example, the transmission assembly 100 may not include the clutch assembly 110 and the prime mover 52 may directly provide the power to the belt assembly 130.

As shown in FIG. 4, the clutch assembly 110 includes a primary clutch assembly (e.g., a first clutch wheel, etc.), shown as primary clutch 112, coupled to the prime mover 52 and configure to be driven by the prime mover 52, a secondary clutch assembly (e.g., a second clutch wheel, etc.), shown as secondary clutch 114, a first belt (e.g., a first torque transfer belt, etc.), shown as clutch belt 116, engaged with the primary clutch 112 and the secondary clutch 114 and configured to be driven by the rotation of the primary clutch 112 to rotate the secondary clutch 114, and a first shaft (e.g., a power shaft, etc.), shown as jack shaft 118, coupled to the secondary clutch 114 and configured to rotate with the secondary clutch 114. As the prime mover 52 drives the primary clutch 112, the power provided by the prime mover 52 is transferred through the clutch assembly 110 to the jack shaft 118 through the rotation of the primary clutch 112 and the secondary clutch 114. In some embodiments, the clutch assembly 110 is configured as a continuous variable transmission clutch (e.g., a CVT system, etc.). By way of example, the primary clutch 112 and the secondary clutch 114 may each include a stationary sheave and moveable sheave. As a rotational speed of the primary clutch 112 and the secondary clutch 114 increase (e.g., based on a speed of the prime mover 52 increasing, etc.), the moveable sheaves of the primary clutch 112 and the secondary clutch 114 are actuated toward or away from the stationary sheave of the primary clutch 112 and the secondary clutch 114. As the moveable sheaves are actuated toward or away from the stationary sheaves, the clutch belt 116 may move between different diameters of the primary clutch 112 and the secondary clutch 114 to change an effective gear ratio of the clutch assembly 110. The clutch assembly 110 may allow for smooth and continuous delivery of the power provided by the prime mover 52 via the jack shaft 118 through the rotation of the jack shaft 118.

As shown in FIG. 4, the belt assembly 130 includes a first sprocket (e.g., first drive sprocket, etc.), shown as top drive sprocket 132, coupled to the jack shaft 118 and configured to rotate with the jack shaft 118, a second belt (e.g., belt system belt, etc.), shown as drive belt 134, engaged with the top drive sprocket 132 and configured to be driven by the top drive sprocket 132, a housing (e.g., a belt bracket, a belt frame, etc.), shown as belt housing 136, coupled to the frame 12 and/or the body 20 and configured to house the other components of the belt assembly 130, and a second sprocket (e.g., second drive sprocket, etc.), shown as bottom drive sprocket 140, engaged with the drive belt 134 and configured to be rotated by the top drive sprocket 132 via the drive belt 134. As the top drive sprocket 132 is rotated with the jack shaft 118, the power provided by the jack shaft 118 to the top drive sprocket 132 is transferred through the belt assembly 130 to the bottom drive sprocket 140 through the drive belt 134. By transferring the power from the top drive sprocket 132 to the bottom drive sprocket 140 via the drive belt 134, the belt assembly 130 may offset the rotation associated with the power received from the clutch assembly 110 from a first axis extending along the jack shaft 118 to a second axis, shown as axis A_{R}, extending along the drive shaft 160.

The configuration of the belt assembly 130 may depend on positions of the drive sprocket 150 and the front tractive assembly 58 and/or the rear tractive assembly 56. By way of example, the top drive sprocket 132 may be driven by the jack shaft 118 to rotate about the first axis extending along the length of the jack shaft 118 and the drive belt 134 may drive the bottom drive sprocket 140 to rotate about the axis A_{R} extending along the drive shaft 160. In other embodiments, the belt assembly 130 includes other components configured to transfer the power from the top drive sprocket 132 to the bottom drive sprocket 140 (e.g., other than using the drive belt 134, etc.). By way of example, the belt assembly 130 may include a chain engaged with the top drive sprocket 132 and the bottom drive sprocket 140 and configured to be driven by the rotation of the top drive sprocket 132 to rotate the bottom drive sprocket 140 to transfer the power from the top drive sprocket 132 to the bottom drive sprocket 140. By way of another example, the belt assembly 130 may include at least one gear engaged with the top drive sprocket 132 and the bottom drive sprocket 140 and configured to be driven by the rotation of the top drive sprocket 132 to rotate the bottom drive sprocket 140 to transfer the power from the top drive sprocket 132 to the bottom drive sprocket 140.

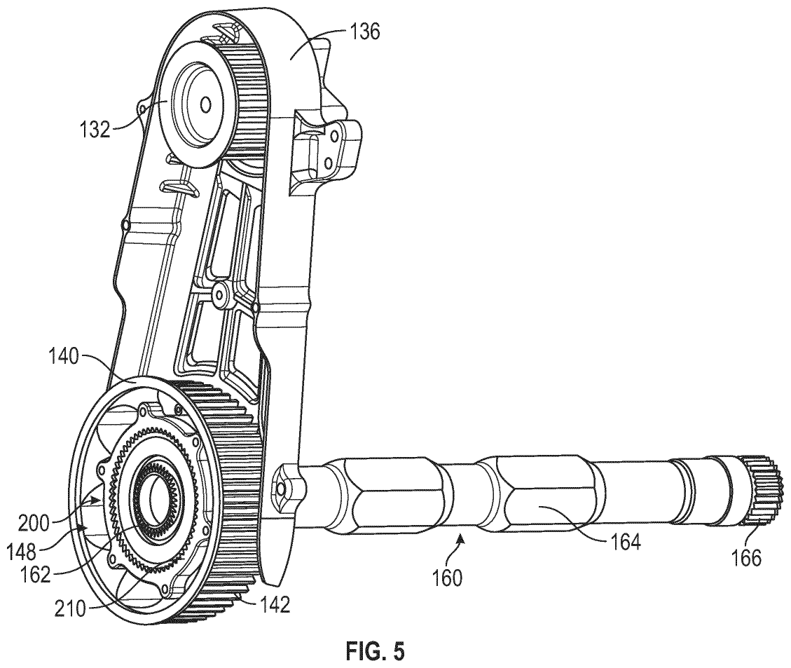

As shown in FIGS. 5 and 7-9, the bottom drive sprocket 140 defines a first spline (e.g., toothed connection, serration, etc.), shown as bottom drive sprocket spline 142, configured to engage the drive belt 134 so that the bottom drive sprocket 140 is rotated by the top drive sprocket 132 via the drive belt 134. In some embodiments, a configuration of the bottom drive sprocket spline 142 varies based on a desired gear ratio of the belt assembly 130. By way of example, if the desired gear ratio of the belt assembly 130 is 1:3 and a spline of the top drive sprocket 132 has ten teeth (e.g., ten grooves, etc.), the bottom drive sprocket spline 142 may have thirty teeth to achieve the desired gear ratio of the belt assembly 130.

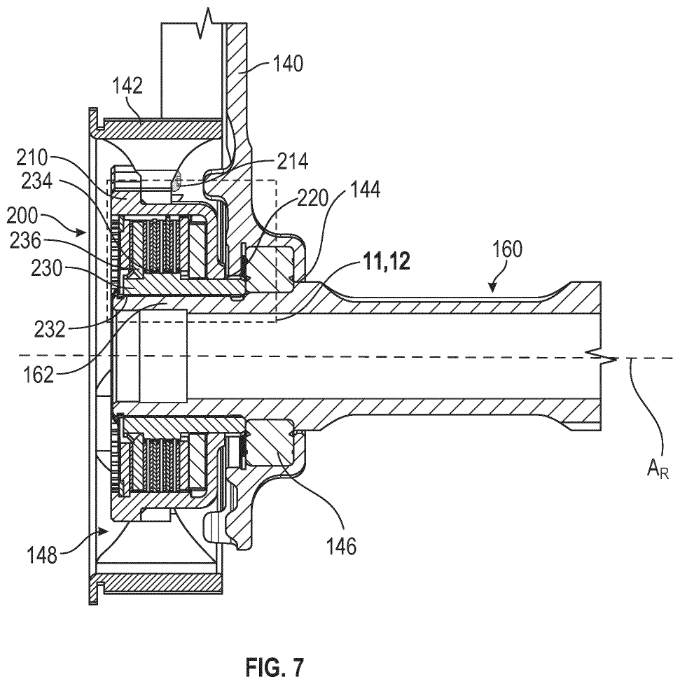

As shown in FIGS. 7-9, the bottom drive sprocket 140 defines a first aperture (e.g., a first hole, a first slot, an aperture, a recess, etc.), shown as bottom drive aperture 144, extending through the bottom drive sprocket 140. The bottom drive aperture 144 may be centered on the axis A_{R} that extends along the length of the drive shaft 160. As shown in FIG. 7, the bottom drive aperture 144 is configured to align with the drive shaft 160 to receive the drive shaft 160 such that the drive shaft 160 extends through the bottom drive aperture 144 to extend through the bottom drive sprocket 140. As shown in FIG. 7, the bottom drive sprocket 140 includes a first bearing (e.g., a first bushing, a first bearing assembly, etc.), shown as drive bearing 146, positioned proximate the bottom drive aperture 144 and configured to receive the drive shaft 160. The drive bearing 146 may support the bottom drive sprocket 140 on the drive shaft 160 while allowing for independent rotation of the bottom drive sprocket 140 and the drive shaft 160 about the axis A_{R}. In other embodiments, the drive bearing 146 at least partially extends through the bottom drive aperture 144. By way of example, the drive bearing 146 may be press fit into the bottom drive aperture 144.

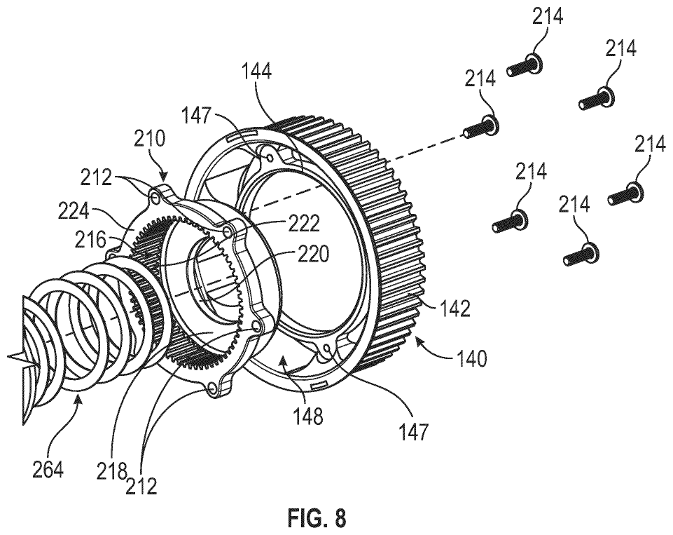

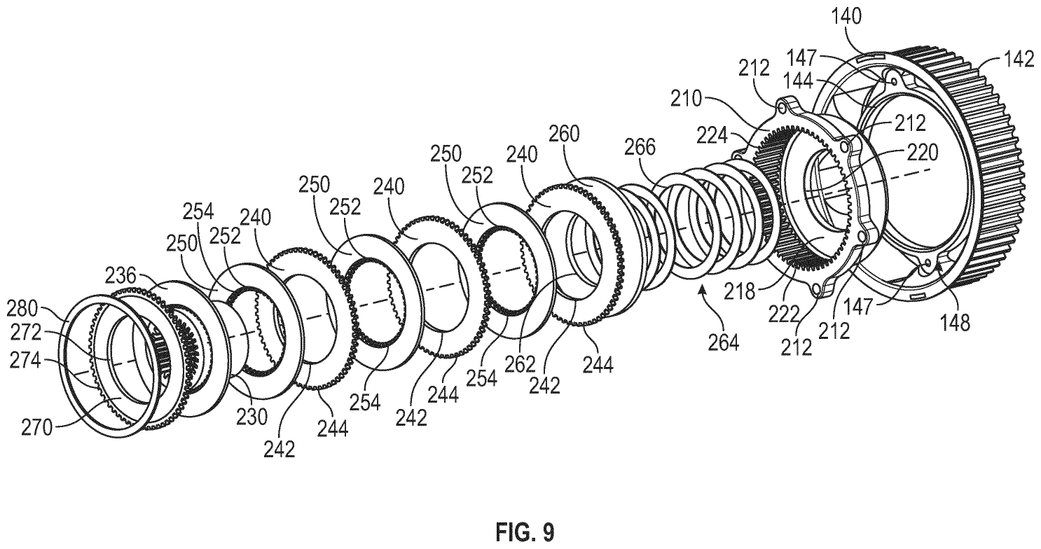

As shown in FIGS. 8 and 9, the bottom drive sprocket 140 defines a plurality of first apertures (e.g., coupling apertures, fastener apertures, etc.), shown as mounting apertures 147, extending through the rear wall of the drive sprocket 140 and around the bottom drive aperture 144. The mounting apertures 147 are configured to couple the bottom drive sprocket 140 to the slip gear assembly 200 (e.g., via fasteners 214, etc.). The mounting apertures 147 may be evenly spaced around the bottom drive aperture 144 and extend parallel to the bottom drive aperture 144.

As shown in FIGS. 5 and 7-9, the bottom drive sprocket 140 defines a first opening (e.g., a slip gear opening, a first cavity, a first chamber, a first recess, etc.), shown as bottom drive sprocket opening 148, extending partially through the bottom drive sprocket 140. The bottom drive sprocket opening 148 is configured to receive at least a portion of the slip gear assembly 200. The bottom drive sprocket opening 148 may extend through the bottom drive sprocket 140 in a direction parallel to the bottom drive aperture 144. In some embodiments, the bottom drive sprocket opening 148 is centered about the axis A_{R}. In other embodiments, the bottom drive sprocket opening 148 is offset from the axis A_{R}.

As shown in FIGS. 5 and 7, the drive shaft 160 includes a first shaft interface (e.g., a first spline, a first torque interface, etc.), shown as gear interface 162, coupled to the slip gear assembly 200 and configured receive power from the slip gear assembly 200, a second shaft interface (e.g., a hex profile interface, a second torque interface, etc.), shown as drive sprocket interface 164, coupled to the drive sprocket 150 and configured to provide power to the drive sprocket 150, and a third shaft interface (e.g., a second spline, a third torque interface, etc.), shown as brake shaft interface 166, coupled to the brake disk 74 and configured to receive the braking from the brake 72 via the brake disk 74 to brake the driveline 50. The gear interface 162 may engage with a profile of the slip gear assembly 200 to couple the drive shaft 160 to the slip gear assembly 200 to receive the power from the slip gear assembly 200. By way of example, the gear interface 162 may be configured as a first spline configured to interface with a second spline of the slip gear assembly 200 to transfer torque between the gear interface 162 and the slip gear assembly 200. The drive sprocket interface 164 may engage with a profile of the drive sprocket 150 to couple the drive shaft 160 to the drive sprocket 150 to provide the power to the drive sprocket 150. By way of example, the drive sprocket interface 164 may be formed in a hexagon shape configured to interface with a hexagon aperture defined by the drive sprocket 150. The brake 72 may engage with a profile of the brake disk 74 to couple the drive shaft 160 to the brake disk 74 to receive the braking from the brake 72.

### Slip Gear Assembly

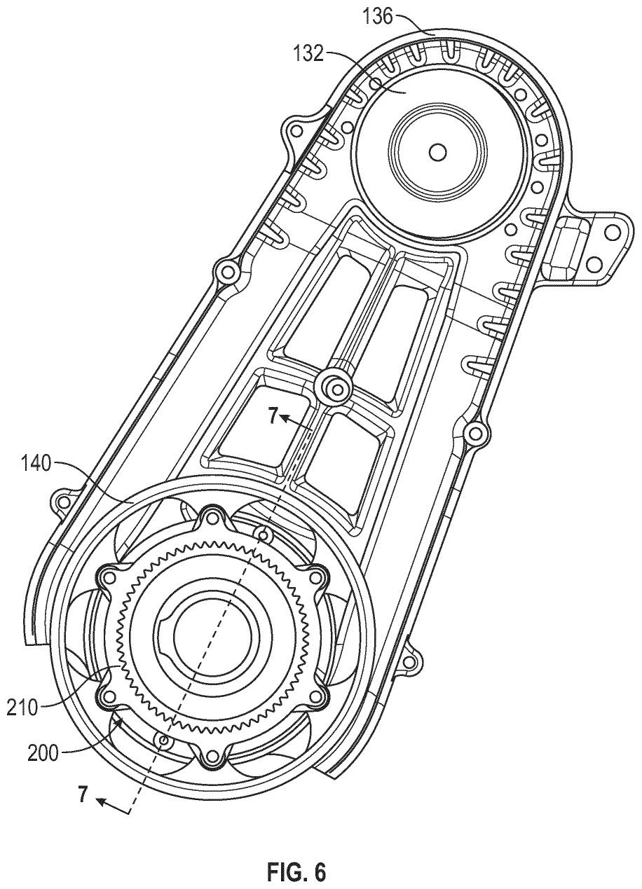

As shown in FIGS. 5-7 and 9, the slip gear assembly 200 is coupled between the bottom drive sprocket 140 and the drive shaft 160 and is configured to transfer the power received by the bottom drive sprocket 140 to the drive shaft 160. While transferring the power received by the bottom drive sprocket 140 to the drive shaft 160, the slip gear assembly 200 is configured limit loads (e.g., torques, forces, etc.) transferred between the bottom drive sprocket 140 and the drive shaft 160. The slip gear assembly 200 may be configured to limit loads above a load threshold (e.g., a torque threshold, a force threshold, etc.) from being transferred between the bottom drive sprocket 140 and the drive shaft 160. As a result, the slip gear assembly 200 may prevent loads above the load threshold applied by the drive shaft 160 on the slip gear assembly 200 from being transferred to the bottom drive sprocket 140, allowing for the operator to continue to drive the vehicle 10 through high loading conditions (e.g., jumps, uneven terrain, terrain with varying traction, etc.).

By way of example, the slip gear assembly 200 may be configured to have a load threshold that is below a loading capacity (e.g., a maximum load rating, a maximum torque rating, etc.) of the bottom drive sprocket 140, the prime mover 52, and/or other components of the transmission assembly 100 configured to transmit power between the bottom drive sprocket 140 and the prime mover 52 (e.g., the clutch assembly 110, the top drive sprocket 132, the drive belt 134, etc.). When a load above the loading capacity is applied to the bottom drive sprocket 140, the prime mover 52, and/or other components of the transmission assembly 100, the bottom drive sprocket 140, the prime mover 52, and/or other components of the transmission assembly 100 may fail (e.g., break, no longer function, etc.), which may create issues with providing power to the front tractive assembly 58 and/or the rear tractive assembly 56 from the prime mover 52 to drive the front tractive assembly 58 and/or the rear tractive assembly 56. As a result, the slip gear assembly 200 limiting the load transferred from the drive shaft 160 to the bottom drive sprocket 140 to the load threshold may protect the bottom drive sprocket 140, the prime mover 52, and/or other components of the transmission assembly 100 from receiving loads above their load capacities.

According to an exemplary embodiment, the slip gear assembly 200 is configured as a dry slip gear assembly (e.g., a non-lubricated slip gear assembly, an open slip gear assembly, etc.) that does not contain a fluid lubricant (e.g., oil, grease, etc.). By way of example, while operating the slip gear assembly 200, the components of the slip gear assembly 200 are configured to slip when loads above the load threshold of the slip gear assembly 200 are applied to the slip gear assembly 200. Various components of the slip gear assembly may be configured as friction plates that directly contact each other. The friction plates may slip when the friction between the materials of the friction plates is overcome by the load. The slip gear assembly 200 may rely on the materials of the friction plates to keep the friction between the friction plates constant instead of relying on fluid lubricant positioned between the friction plates to keep the friction constant. As a result, the slip gear assembly 200 does not need to be fluid tight (e.g., water-tight, etc.) as the slip gear assembly 200 does not need to contain a fluid. Additionally, the slip gear assembly 200 does not need to incorporate rotating seals between components of the slip gear assembly 200 that rotate relative each other in order to contain fluid lubricants, which can complicate assemblies and are common points of failure of assemblies. By way of example, the components of the slip gear assembly 200 may be open (e.g., fluidly accessible, etc.) to an environment surrounding the slip gear assembly 200. As a result, fluids contained within the slip gear assembly 200 (e.g., moisture, snow melt, etc.) may drain from the slip gear assembly 200 and not corrode the components of the slip gear assembly 200.

As shown in FIGS. 5-9, 11, and 12, the slip gear assembly 200 includes a first body (e.g., first housing, first bracket, etc.), shown as slip gear outer body 210, removably coupled to the bottom drive sprocket 140 and configured to rotate with the bottom drive sprocket 140; a second body (e.g., a second housing, a second bracket, etc.), shown as slip gear inner body 230, removably coupled to the drive shaft 160 and configured to rotate with the drive shaft 160, a first plurality of pressure plates, shown as outer pressure plates 240, configured to engage the slip gear outer body 210 and rotate with the slip gear outer body 210, and a second plurality of pressure plates, shown as inner pressure plates 250, configured to engage in the slip gear inner body 230 and rotate with the slip gear inner body 230. In some embodiments, the slip gear outer body 210, the slip gear inner body 230, the outer pressure plates 240, and the inner pressure plates 250 are configured to rotate about the axis A_{R}. As the bottom drive sprocket 140 is rotated by the drive belt 134, the slip gear outer body 210 may rotate at the same rotational speed as the bottom drive sprocket 140. In some embodiments, the slip gear outer body 210 is at least partially received within the bottom drive sprocket opening 148. In other embodiments, the slip gear outer body 210 is positioned outside of the bottom drive sprocket opening 148.

As shown in FIGS. 8 and 9, the slip gear outer body 210 defines a plurality of second apertures, shown as outer body apertures 212, extending through the slip gear outer body 210. The outer body apertures 212 are configured to align with the mounting apertures 147 of the bottom drive sprocket 140 to selectively receive a plurality of fasteners (e.g., bolts, screws, rivets, nails, anchors, etc.), shown as outer body fasteners 214, to removably couple the slip gear outer body 210 to the bottom drive sprocket 140. The outer body fasteners 214 may transfer the power from the bottom drive sprocket 140 to the slip gear outer body 210 to transfer the power from the bottom drive sprocket 140 to the slip gear assembly 200.

As shown in FIGS. 8 and 9, the slip gear outer body 210 defines a second opening (e.g., a second cavity, a slip gear assembly cavity, a second chamber, a second recess, etc.), shown as slip gear cavity 216, extending partially through the slip gear outer body 210. The slip gear cavity 216 is configured to receive the outer pressure plates 240, the inner pressure plates 250, and the slip gear inner body 230. According to an exemplary embodiment, the slip gear cavity 216 is open to an environment surrounding the vehicle 10. By way of example, the slip gear assembly 200 may not be sealed off from the environment by a seal (e.g., a gasket, a fluid seal, etc.). The slip gear cavity 216 may be centered around the axis A_{R}. By way of example, the slip gear cavity 216 may be a cylindrical cavity that is centered on a rotational axis that the slip gear outer body 210 rotates around when the slip gear outer body 210 rotates with the bottom drive sprocket 140. As shown in FIGS. 8, 9, 11, and 12, the slip gear outer body 210 includes a first surface (e.g., a first contact surface, etc.), shown as slip gear contact surface 218, that defines a bottom or rear of the slip gear cavity 216. The slip gear contact surface 218 is oriented perpendicular to the axis A_{R}.

As shown in FIGS. 8, 9, 11, and 12, the slip gear outer body 210 defines a third aperture, shown as outer body shaft aperture 220, extending through the slip gear outer body 210. In some embodiments, the outer body shaft aperture 220 extends through the slip gear contact surface 218. By way of example, when the slip gear cavity 216 is configured as a cylindrical cavity and the outer body shaft aperture 220 is circular, a first radius of the slip gear cavity 216 may be greater than a second radius of the outer body shaft aperture 220. The outer body shaft aperture 220 may be centered on the axis A_{R} that extends along the length of the drive shaft 160. As shown in FIG. 7, the outer body shaft aperture 220 is configured to align with and receive the drive shaft 160 such that the drive shaft 160 extends through the slip gear outer body 210. In some embodiments, the outer body shaft aperture 220 is configured to align with and receive the slip gear inner body 230 such that the slip gear inner body 230 extends through the outer body shaft aperture 220.

As shown in FIGS. 8, 9, 11, and 12, the slip gear outer body 210 includes a first engagement interface, shown as outer body engagement interface 222, extending around an inner surface of the slip gear outer body 210 defined by the slip gear cavity 216. The outer body engagement interface 222 is configured to engage the outer pressure plates 240 to couple the outer pressure plates 240 to the slip gear outer body 210. By way of example, the outer body engagement interface 222 may engage the outer pressure plates 240 to transfer the power provided by the prime mover 52 from the slip gear outer body 210 to the outer pressure plates 240. In some embodiments, the outer body engagement interface 222 extends along a depth of the slip gear cavity 216 from the slip gear contact surface 218 to a top or front of the slip gear cavity 216. According to an exemplary embodiment, the outer body engagement interface 222 is configured as a first portion of a spline connection (e.g., an involute spline connection, a straight-sided spline connection, a helical spine connection, etc.) between the slip gear outer body 210 and the outer pressure plates 240. For example, the outer body engagement interface 222 may be configured as a female spline portion of the spline connection configured to engage male spline portions of the outer pressure plates 240 to couple the slip gear outer body 210 to the outer pressure plates 240. In other embodiments, the outer body engagement interface 222 is configured as a first portion of other mating connections configured to engage second portions of the other mating connections defined by the outer pressure plates 240. For example, the outer body engagement interface 222 may be configured as a female portion of a polygonal connection (e.g., a hexagonal connection, an octagonal connection, etc.), a female portion of a keyed connection, etc.

As shown in FIGS. 8, 9, 11, and 12, the slip gear outer body 210 defines a groove (e.g., a gap, etc.), shown as retainer groove 224, extending around the inner surface of the slip gear outer body 210 defined by the slip gear cavity 216 and radially outward from the slip gear cavity into the slip gear outer body 210. By way of example, when the slip gear cavity 216 is configured as a cylindrical cavity, the first radius of the slip gear cavity 216 may be less than a third radius of the retainer groove 224. The retainer groove 224 may be positioned between the top of the slip gear cavity 216 and the slip gear contact surface 218.

As shown in FIGS. 7 and 10-12, the slip gear inner body 230 includes a fourth shaft interface (e.g., fourth torque interface, etc.), shown as axle interface 232, extending through the slip gear inner body 230 and configured to engage the gear interface 162 of the drive shaft 160 to couple the slip gear inner body 230 to the drive shaft 160. The axle interface 232 is configured to engage the gear interface 162 to rotate the drive shaft 160 with the slip gear inner body 230. The axle interface 232 may transfer power from the slip gear inner body 230 to the drive shaft 160 through the gear interface 162. According to an exemplary embodiment, the axle interface 232 and the gear interface 162 are configured as opposing portions of a spline connection between the axle interface 232 and the gear interface 162. By way of example, the axle interface 232 may be configured as a female spline portion and the gear interface 162 may be configured as a male spline portion configured to engage the female spile portion to couple the slip gear inner body 230 to the drive shaft 160. In other embodiments, the axle interface 232 and the gear interface 162 are configured as other mating connections configured to couple the slip gear inner body 230 to the drive shaft 160. By way of example, the axle interface 232 and the gear interface 162 may be configured as opposing portions of a polygonal connection, a keyed connection, etc.

As shown in FIGS. 7 and 10-12, the slip gear inner body 230 includes a second engagement interface, shown as inner body engagement interface 234, extending around an outer surface of the slip gear inner body 230. The inner body engagement interface 234 is configured to engage the inner pressure plates 250 to couple the inner pressure plates 250 to the slip gear inner body 230. By way of example, the inner body engagement interface 234 may engage the inner pressure plates 250 to transfer the power provided by the prime mover 52 from the inner pressure plates 250 to the slip gear inner body 230. According to an exemplary embodiment, the inner body engagement interface 234 is configured as a first portion of a spline connection between the slip gear inner body 230 and the inner pressure plates 250. By way of example, the inner body engagement interface 234 may be configured as a male spline portion of the spine connection configured to engage female spine portions of the inner pressure plates 250 to couple the slip gear inner body 230 to the inner pressure plates 250. In other embodiments, the inner body engagement interface 234 is configured as a first portion of other mating connections configured to engage second portions of the other mating connections included in the inner pressure plates 250. For example, the inner body engagement interface 234 may be configured as a male portion of a polygonal connection, a male portion of a keyed connection, etc.

As shown in FIGS. 7 and 9-12, the slip gear inner body 230 includes a flange, shown as inner body flange 236, extending outward at an end of the slip gear inner body 230. The inner body flange 236 is configured to retain (e.g., contain, etc.) the outer pressure plates 240 and the inner pressure plates 250 between the inner body flange 236 and the slip gear contact surface 218. By way of example, the inner body flange 236 and the slip gear contact surface 218 may prevent the outer pressure plates 240 from disengaging from the outer body engagement interface 222 and the inner pressure plates 250 from disengaging from the inner body engagement interface 234. The inner body flange 236 extends further than the inner body engagement interface 234 such that a first maximum radius of the inner body flange 236 is greater than a second maximum radius of the inner body engagement interface 234.

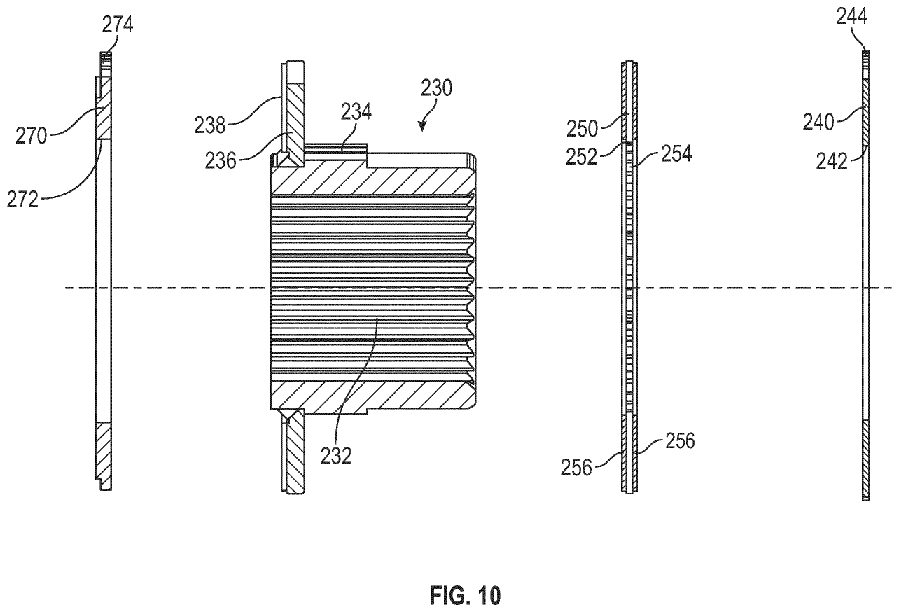

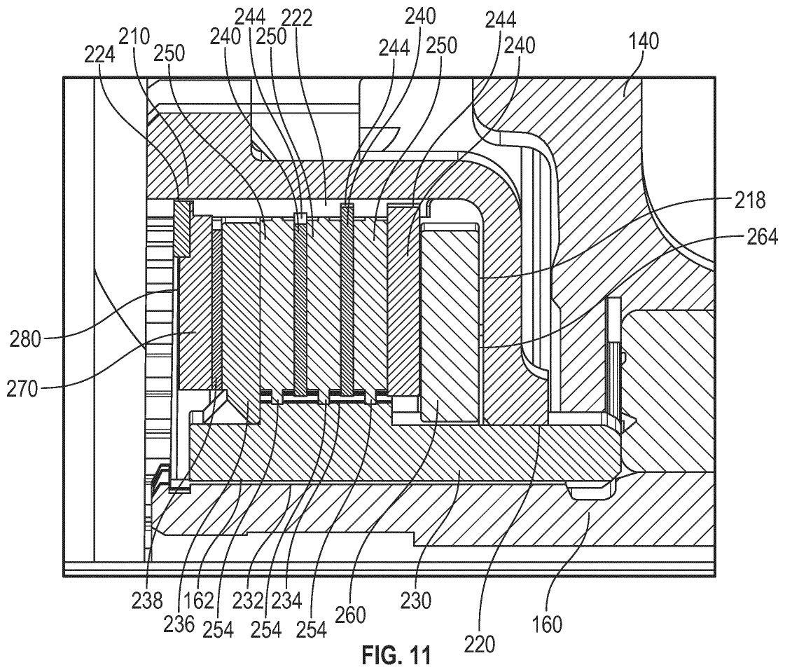

According to an exemplary embodiment, the inner body flange 236 includes at least one first friction surface positioned on a side of the inner body flange 236. The first friction surface may extend in a direction perpendicular to the axis A_{R}. In some embodiments, the inner body flange 236 is formed from steel (e.g., hardened steel, etc.) and the first friction surface may have first friction properties based on friction properties of the steel. By way of example, the inner body flange 236 may be formed from steel to accommodate the loads on the inner body flange 236 from retaining the outer pressure plates 240 and the inner pressure plates 250. According to the exemplary embodiment shown in FIGS. 10 and 11, the first friction surface of the inner body flange 236 is coated with a coating (e.g., a copper coating, a ceramic coating, a dry lubricant coating, a rubber coating, etc.), shown as flange surface coating 238, formed from a material with high friction properties (e.g., copper, ceramic, dry lubricant, rubber, materials with a high surface roughness, materials with a low hardness, materials with higher friction properties than steel, etc.) so that the first friction surface may form a high coefficient of friction with other surfaces (e.g., higher than a coefficient of friction between two steel surfaces, etc.). By way of example, the inner body flange 236 may be formed from steel to accommodate the loads on the inner body flange 236 from retaining the outer pressure plates 240 and the inner pressure plates 250 and the first friction surface of the inner body flange 236 may be coated with the flange surface coating 238 formed from copper, dry lubricant, rubber, and/or ceramic. In other embodiments, the inner body flange 236 is formed from materials that have high friction properties so that the first friction surface of the inner body flange 236 may form high coefficients of friction with other surfaces. By way of example, the inner body flange 236 may be formed from copper, ceramic, rubber, or other materials with higher friction properties than steel.

As shown in FIGS. 9 and 10, each of the outer pressure plates 240 define a fourth aperture, shown as outer plate aperture 242, extending through the outer pressure plates 240. The outer plate aperture 242 may be centered on the axis A_{R} that extends along the length of the drive shaft 160. The outer plate apertures 242 are configured to align with and receive the drive shaft 160 such that the drive shaft 160 extends through the outer pressure plates 240. In some embodiments, the outer plate apertures 242 are configured to align with and receive the slip gear inner body 230 such that the slip gear inner body 230 extends through the outer plate apertures 242.

As shown in FIGS. 9-12, each of the outer pressure plates 240 include a third engagement interface, shown as outer plate engagement interface 244, extending around an outer surface or periphery of the outer pressure plates 240. The outer plate engagement interfaces 244 are configured to engage the outer body engagement interface 222 of the slip gear outer body 210 to couple the outer pressure plates 240 to the slip gear outer body 210. By way of example, the outer body engagement interfaces 222 may engage with the outer plate engagement interface 244 to transfer the power provided by the prime mover 52 from the slip gear outer body 210 to the outer pressure plates 240. According to an exemplary embodiment, the outer plate engagement interfaces 244 are configured as the second portions of the spline connection between the slip gear outer body 210 and the outer pressure plates 240. By way of example, the outer plate engagement interfaces 244 may be configured as the male portions of the spline connection configured to engage the outer body engagement interface 222 configured as the female portion of the spline connection. In other embodiments, the outer plate engagement interfaces 244 are configured as the second portions of other mating connections configured to engage the outer body engagement interface 222 configured as the first portion of the other mating connections.

According to an exemplary embodiment, each of the outer pressure plates 240 includes second friction surfaces positioned on opposing sides of the outer pressure plates 240. The second friction surfaces of the outer pressure plates 240 may extend along the outer pressure plates 240 in a direction perpendicular to the axis A_{R}. In some embodiments, the outer pressure plates 240 are formed from steel (e.g., hardened steel, etc.) and the second friction surfaces may have second friction properties based on friction properties of the steel. By way of example, the outer pressure plates 240 may be formed from steel to accommodate the loads transferred between the slip gear outer body 210 and the outer pressure plates 240 via the engagement of the outer body engagement interface 222 with the outer plate engagement interfaces 244. In other embodiments, the outer pressure plates 240 are formed from materials that have high friction properties (e.g., high surface roughness, low hardness, friction properties than steel, etc.) so that the second friction surfaces may form high coefficients of friction with other surfaces. By way of example, the outer pressure plates 240 may be formed from copper, ceramic, rubber, or other materials with higher friction properties than steel. In still other embodiments, the second friction surfaces of the outer pressure plates 240 are coated with a material with high friction properties (e.g., higher than steel, etc.) so that the second friction surfaces may form high coefficients of friction with other surfaces (e.g., higher than a coefficient of friction between two steel surfaces, etc.). By way of example, the outer pressure plates 240 may be formed from steel to accommodate the loads transferred between the slip gear outer body 210 and the outer pressure plates 240 via the engagement of the outer body engagement interface 222 with the outer plate engagement interfaces 244 and the second friction surfaces of the outer pressure plates 240 may be coated with copper, a solid lubricant, rubber, and/or ceramic.

As shown in FIGS. 9 and 10, each of the inner pressure plates 250 define a fifth aperture, shown as inner plate aperture 252, extending through the inner pressure plates 250. The inner plate aperture 252 may be centered on the axis A_{R} that extends along the length of the drive shaft 160. The inner plate apertures 252 are configured to align with and receive the drive shaft 160 such that the drive shaft 160 extends through the inner pressure plates 250. In some embodiments, the inner plate apertures 252 are configured to align with and receive the slip gear inner body 230 such that the slip gear inner body 230 extends through the inner plate apertures 252.

As shown in FIGS. 9-12, each of the inner pressure plates 250 includes a fourth engagement interface, shown as inner plate engagement interface 254, extending around an inner surface or periphery of the inner pressure plates 250 defined by the inner plate aperture 252. The inner plate engagement interfaces 254 are configured to engage the inner body engagement interface 234 of the slip gear inner body 230 to couple the inner pressure plates 250 to the slip gear inner body 230. By way of example, the inner plate engagement interfaces 254 may engage with the inner body engagement interface 234 to transfer the power provided by the prime mover 52 from the inner pressure plates 250 to the slip gear inner body 230. According to an exemplary embodiment, the inner plate engagement interfaces 254 are configured as the second portions of the spline connection between the slip gear inner body 230 and the inner pressure plates 250. By way of example, the inner plate engagement interfaces 254 may be configured as the female portions of the spline connection configured to engage the inner body engagement interface 234 configured as the female portion of the spine connection. In other embodiments, the inner plate engagement interfaces are configured as the second portions of other mating connections configured to engage the inner body engagement interface 234 configured as the first portion of the other mating connections.

According to an exemplary embodiment, each of the inner pressure plates 250 include third friction surfaces positioned on opposing sides of the inner pressure plates 250. The third friction surfaces may extend in a direction perpendicular to the axis A_{R}. In some embodiments, the inner pressure plates 250 are formed from steel (e.g., hardened steel, etc.) and the third friction surfaces may have third friction properties based on friction properties of the steel. By way of example, the inner pressure plates 250 may be formed from steel to accommodate the loads transferred between the inner pressure plates 250 and the slip gear inner body 230 via the engagement of the inner body engagement interface 234 with the inner plate engagement interface 254. According to the exemplary embodiment shown in FIG. 10, the third friction surfaces of the inner pressure plates 250 are coated with a coating (e.g., a copper coating, a ceramic coating, a rubber coating, a dry lubricant coating, etc.), shown as inner plate surface coating 256, formed from a material with high friction properties (e.g., copper, rubber, ceramic, dry lubricant, materials with a high surface roughness, materials with a low hardness, materials with higher friction properties than steel, etc.) so that the third friction surfaces may form a high coefficient of friction with the second friction surfaces of the outer pressure plates 240 and/or other surfaces (e.g., higher than a coefficient of friction between two steel surfaces, etc.). By way of example, the inner pressure plates 250 may be formed from steel to accommodate the loads transferred between the slip gear inner body 230 and the inner pressure plates 250 via the engagement of the inner body engagement interface 234 with the inner plate engagement interface and the third friction surfaces of the inner pressure plates 250 may be coated with the inner plate surface coating 256 formed from copper, rubber, dry lubricant, and/or ceramic. In other embodiments, the inner pressure plates 250 are formed from materials that have high friction properties so that the third friction surface of the inner pressure plates 250 may form high coefficients of friction with the second friction surfaces of the outer pressure plates 240 and/or other surfaces. By way of example, the inner pressure plates 250 may be formed from copper, rubber, ceramic, or other materials with higher friction properties than steel.

As shown in FIGS. 9-12, the outer pressure plates 240 and the inner pressure plates 250 may be arranged in alternating pattern between the inner body flange 236 of the slip gear inner body 230 and the slip gear contact surface 218 of the slip gear outer body 210. By way of example, the outer pressure plates 240 and the inner pressure plates 250 may be arranged in a direction from the inner body flange 236 of the slip gear inner body 230 to the slip gear contact surface 218 of the slip gear outer body 210 as a first of the inner pressure plates 250, followed by a first of the outer pressure plates 240, followed by a second of the inner pressure plates 250, followed by a second of the outer pressure plates 240, followed by a third of the inner pressure plates 250, followed by a third of the outer pressure plates 240. In other embodiments, the slip gear assembly 200 includes a different number of the inner pressure plates 250 and a different number of the outer pressure plates 240 positioned between the inner body flange 236 of the slip gear inner body 230 and the slip gear contact surface 218 of the slip gear outer body 210 (e.g., one, two, four, etc.).

According to the exemplary embodiment shown in FIGS. 9-11, the outer pressure plates 240 and the inner pressure plates 250 are arranged in the slip gear assembly 200 such that at least one of the second friction surfaces of each of the outer pressure plates 240 is in contact (e.g., direct contact, etc.) with one of the third friction surfaces of the inner pressure plates 250 to form a coefficient of friction between the second friction surfaces of the outer pressure plates 240 that are in contact with the third friction surfaces of the inner pressure plates 250. The friction between the second friction surfaces of the outer pressure plates 240 and the third friction surfaces of the inner pressure plates 250 may allow for the outer pressure plates 240 to selectively couple with the inner pressure plates 250 when a load torque (e.g., a load, a load force, etc.) applied on the inner pressure plates 250 by the outer pressure plates 240 is less than a friction torque (e.g., a friction force, etc.) between the second friction surfaces of the outer pressure plates 240 and the third friction surfaces of the inner pressure plates 250. When the load torque applied on the outer pressure plates 240 by the inner pressure plates 250 exceeds the friction torque between the second friction surfaces of the outer pressure plates 240 and the third friction surfaces of the inner pressure plates 250, the friction coupling the second friction surfaces of the outer pressure plates 240 and the third friction surfaces of the inner pressure plates 250 may be overcome and the outer pressure plates 240 may rotate (e.g., slip, etc.) relative to the inner pressure plates 250. By way of example, when a load applied on the outer pressure plates 240 and/or the inner pressure plates 250 exceeds the load threshold of the slip gear assembly 200, the load torque applied on the outer pressure plates 240 by the inner pressure plates 250 may overcome the friction torque between the second friction surfaces of the outer pressure plates 240 and the third friction surfaces of the inner pressure plates 250, causing the inner pressure plates 250 to slip relative to the outer pressure plates 240 and the load to not be transferred between the outer pressure plates 240 and the inner pressure plates 250.

In some embodiments, the positions of the outer pressure plates 240 and/or the inner pressure plates 250 are swapped (e.g., changed, etc.) for other configurations of the outer pressure plates 240 and/or the inner pressure plates 250 to modify the load threshold of the slip gear assembly 200. By way of example, since the friction torque between the outer pressure plates 240 and the inner pressure plates 250 depends on the coefficient of friction between the second friction surfaces of the outer pressure plates 240 and the third friction surfaces of the inner pressure plates 250, the load threshold of the slip gear assembly 200 may be modified by changing the coefficient of friction between the second friction surfaces of the outer pressure plates 240 and the third friction surfaces of the inner pressure plates 250. If a first combination of the outer pressure plates 240 and the inner pressure plates 250 where the third friction surface of the inner pressure plates 250 are coated in ceramic results in a first coefficient of friction and a second combination of the outer pressure plates 240 and the inner pressure plates 250 where the third friction surface of the inner pressure plates 250 are coated in copper results in a second coefficient of friction different than the first coefficient of friction, the outer pressure plates 240 and the inner pressure plates 250 may be changed between the first combination and the second combination to increase or decrease the load threshold of the slip gear assembly 200.

As shown in FIGS. 9, 11, and 12, the slip gear assembly 200 includes a compression component (e.g., a spring, a compression bushing, a Belleville washer, a disc spring, etc.), shown as spring 260, positioned between (i) the slip gear contact surface 218 of the slip gear outer body 210 and (ii) the outer pressure plates 240 and the inner pressure plates 250. The spring 260 may be placed in compression to provide a normal force on the outer pressure plates 240 and the inner pressure plates 250. The normal force applied by the spring 260 on the outer pressure plates 240 and the inner pressure plates 250 is in a direction parallel to the axis A_{R} and is configured to push the outer pressure plates 240 and the inner pressure plates 250 towards the inner body flange 236 of the slip gear inner body 230. In other embodiments, the spring 260 is positioned between (i) the inner body flange 236 and (ii) the outer pressure plates 240 and the inner pressure plates 250 so that the normal force applied by the spring 260 on the outer pressure plates 240 and the inner pressure plates 250 towards the slip gear contact surface 218. In still other embodiments, the spring 260 is positioned between at least one of the outer pressure plates 240 and at least one of the inner pressure plates 250. In various embodiments, the slip gear assembly 200 includes a plurality of the springs 260.

As shown in FIG. 9, the spring 260 defines a sixth aperture, shown as spring aperture 262, extending through the spring 260. The spring aperture 262 may be centered on the axis A_{R} that extends along the length of the drive shaft 160. The spring aperture 262 is configured to align with and receive the drive shaft 160 such that the drive shaft 160 extends through the spring 260. In some embodiments, the spring aperture 262 is configured to align with and receive the slip gear inner body 230 such that the slip gear inner body 230 extends through the spring 260.

In some embodiments, the spring 260 is swapped (e.g., changed, etc.) for other configurations of the spring 260 to modify the load threshold of the slip gear assembly 200. By way of example, since the friction torque between the outer pressure plates 240 and the inner pressure plates 250 depends on a force between the outer pressure plates 240 and the inner pressure plates 250 perpendicular to the second friction surfaces of the outer pressure plates 240 and the third friction surfaces of the inner pressure plates 250, the load threshold of the slip gear assembly 200 may be modified by changing the normal force applied by the spring 260 on the outer pressure plates 240 and the inner pressure plates 250. If a first of the springs 260 with a first spring constant results in a first normal force being applied by the spring 260 on the outer pressure plates 240 and the inner pressure plates 250 and a second of the springs 260 with a second spring constant higher than the first spring constant results in a second normal force that is higher than the first normal force being applied by the spring 260 on the outer pressure plates 240 and the inner pressure plates 250, the slip gear assembly 200 may be changed from including the first of the springs 260 to including the second of the springs 260 to increase the load threshold of the slip gear assembly 200.

As shown in FIGS. 8, 9, 11, and 12, the slip gear assembly 200 includes at least one spacer (e.g., a filler, an insert, a washer, etc.), shown as shim 264, positioned between the spring 260 and the slip gear contact surface 218 of the slip gear outer body 210. The shim 264 is configured to change a spacing of the spring 260 relative to the slip gear contact surface 218. By way of example, the shim 264 may be added between the spring 260 and the slip gear contact surface 218 to increase a compression of the spring 260, thereby increasing the normal force provided by the spring 260 on the outer pressure plates 240 and the inner pressure plates 250. In some embodiments, the slip gear assembly 200 includes multiple of the shims 264 (i.e., a shim stack) positioned between the spring 260 and the slip gear contact surface 218 of the slip gear outer body 210. The multiple of the shims 264 may further increase the compression of the spring 260. In other embodiments, the shim 264 is positioned between the spring 260 and the inner body flange 236 (e.g., when the spring 260 is positioned between (i) the inner body flange 236 and (ii) the outer pressure plates 240 and the inner pressure plates 250, etc.). In still other embodiments, the slip gear assembly 200 does not include the shim 264.

As shown in FIG. 9, the shim 264 defines a seventh aperture, shown as shim aperture 266, extending through the shim 264. The shim aperture 266 may be centered on the axis A_{R} that extends along the length of the drive shaft 160. The shim aperture 266 is configured to align with and receive the drive shaft 160 such that the drive shaft 160 extends through the shim 264. In some embodiments, the shim aperture 266 is configured to align with and receive the slip gear inner body 230 such that the slip gear inner body 230 extends through the shim 264.

In some embodiments, the shim 264 is swapped (e.g., changed, etc.) for another configuration of the shim 264 to modify the load threshold of the slip gear assembly 200. By way of example, since the friction torque between the outer pressure plates 240 and the inner pressure plates 250 depends on the normal force between the outer pressure plates 240 and the inner pressure plates 250, the load threshold of the slip gear assembly 200 may be modified by changing the normal force applied by the spring 260 on the outer pressure plates 240 and the inner pressure plates 250. If a first of the shims 264 with a first thickness causes a first compression of the spring 260 that results in a first normal force being applied by the spring 260 on the outer pressure plates 240 and the inner pressure plates 250 and a second of the shims 264 with a second thickness that is greater than the first thickness causes a second compression of the spring 260 results in a second normal force that is higher than the first normal force being applied by the spring 260 on the outer pressure plates 240 and the inner pressure plates 250, the slip gear assembly 200 may be changed from including the first of the shims 264 to including the second of the shims 264 to increase the load threshold of the slip gear assembly 200. In various embodiments, the shims 264 are added or removed from the slip gear assembly 200 to modify the load threshold of the slip gear assembly 200.

As shown in FIGS. 9-12, the slip gear assembly 200 includes a plate (e.g., a retainer plate, a retention plate, etc.), shown as face plate 270, configured to engage the slip gear outer body 210 and rotate with the slip gear outer body 210. As shown in FIGS. 9 and 10, the face plate 270 defines an eight aperture, shown as face plate aperture 272, extending through the face plate 270. The face plate aperture 272 may be centered on the axis A_{R} that extends along the length of the drive shaft 160. The face plate aperture 272 is configured to align with and receive the drive shaft 160 such that the drive shaft 160 extends through the face plate 270. In some embodiments, the face plate aperture 272 is configured to align with and receive the slip gear inner body 230 such that the slip gear inner body 230 extends through the face plate 270.

As shown in FIGS. 9 and 10, the face plate 270 includes a fifth engagement interface, shown as face plate engagement interface 274, extending around an outer surface or periphery of the face plate 270. The face plate engagement interface 274 is configured to engage the outer body engagement interface 222 of the slip gear outer body 210 to couple the face plate 270 to the slip gear outer body. By way of example, the outer body engagement interfaces 222 may engage with the face plate engagement interface 274 to transfer the power provided by the prime mover 52 from the slip gear outer body 210 to the face plate 270. According to an exemplary embodiment, the face plate engagement interface 274 is configured as the second portion of the spline connection between the slip gear outer body 210 and the face plate 270. By way of example, the face plate engagement interface 274 may be configured as the male portion of the spline connection configured to engage the outer body engagement interface 222 configured as the female portion of the spline connection. In other embodiments, the face plate engagement interface 274 is configured as the second portion of other mating connections configured to engage the outer body engagement interface 222 configured as the first portion of the other mating connections.

According to an exemplary embodiment, the face plate 270 includes a fourth friction surface positioned on a surface of the face plate 270. The fourth friction surface of the face plate 270 may extend along the face plate 270 in a direction perpendicular to the axis A_{R}. In some embodiments, the face plate 270 is formed from steel (e.g., hardened steel, etc.) and the fourth friction surface may have fourth friction properties based on friction properties of steel. By way of example, the face plate 270 may be formed from steel to accommodate the loads transferred between the slip gear outer body 210 and the face plate 270 via the engagement of the outer body engagement interface 222 with the face plate engagement interface 274. In other embodiments, the face plate 270 is formed from materials that have high friction properties (e.g., high surface roughness, low hardness, friction properties than steel, etc.) so that the fourth friction surface may form a high coefficient of friction with the third friction surface of the inner body flange 236 and/or other surfaces. By way of example, the face plate 270 may be formed from copper, ceramic, rubber, or other materials with higher friction properties than steel. In still other embodiments, the fourth friction surface of the face plate 270 is coated with a material with high friction properties (e.g., higher than steel, etc.) so that the fourth friction surface may form high coefficient of friction with the third friction surface of the inner body flange 236 and/or other surfaces (e.g., higher than a coefficient of friction between two steel surfaces, etc.). By way of example, the face plate 270 may be formed from steel to accommodate the loads transferred between the slip gear outer body 210 and the face plate 270 via the engagement of the outer body engagement interface 222 with the face plate engagement interface 274 and the fourth friction surfaces of the face plate 270 may be coated with copper, rubber, a solid lubricant, and/or ceramic.

As shown in FIGS. 9, 11, and 12, the slip gear assembly 200 includes a retainer (e.g., a retainer clip, a retainer body, etc.), shown as retainer ring 280, coupled to the slip gear outer body 210 and configured to interface with the face plate 270. A first portion of the retainer ring 280 extends into the retainer groove 224 and a second portion of the retainer ring 280 contacts the face plate 270 to prevent the face plate 270, the outer pressure plates 240, the inner pressure plates 250, the spring 260, and/or the shim 264 from being removed from the slip gear cavity 216. By way of example, when the retainer ring 280 extends into the retainer groove 224 and contacts the face plate 270, the retainer ring 280 may hold the face plate 270, the outer pressure plates 240, the inner pressure plates 250, the spring 260, and/or the shim 264 between the retainer ring 280 and the slip gear contact surface 218 of the slip gear outer body 210. When the retainer ring 280 is positioned in the retainer groove 224, the spring 260 is compressed and applies the normal force on the outer pressure plates 240 and the inner pressure plates 250. In some embodiments, the retainer ring 280 transfers the normal force applied by the spring 260 on the outer pressure plates 240 and the inner pressure plates 250 to the slip gear outer body 210. By way of example, the spring 260 may be compressed by the slip gear contact surface 218 of the slip gear outer body 210 via the shim 264 on a first side of the spring 260 and by the retainer groove 224 of the slip gear outer body 210 via the retainer ring 280, the face plate 270, the outer pressure plates 240, and the inner pressure plates 250 on a second side of the spring 260.

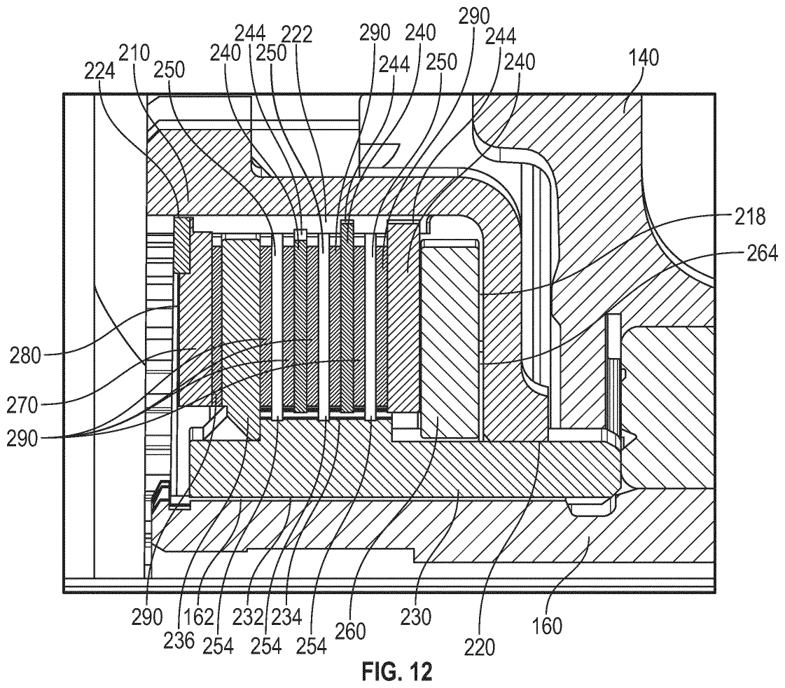

According to the exemplary embodiment shown in FIGS. 11 and 12, the outer pressure plates 240 vary in thickness. By way of example, the outer pressure plate 240 positioned closest to the spring 260 may have a first thickness that is greater than a second thickness of the other of the outer pressure plates 240 to accommodate the normal force applied on the outer pressure plate 240 positioned closest to the spring 260 by the spring 260. In some embodiments, the inner pressure plates 250 vary in thickness.

According to the exemplary embodiment shown in FIG. 12, the slip gear assembly 200 includes a plurality of discs (e.g., friction discs, etc.), shown as insert discs 290, inserted between the outer pressure plates 240 and the inner pressure plates 250. The insert discs 290 include fifth friction surfaces positioned on opposing sides of the insert discs 290. The fifth friction surface may extend in a direction perpendicular to the axis A_{R}. According to the exemplary embodiment shown in FIG. 12, the insert discs 290 are formed from materials that have high friction properties (e.g., copper, rubber, ceramic, materials with a high surface roughness, materials with a low hardness, materials with higher friction properties than steel, etc.) so that the fifth friction surfaces of the insert discs 290 may form high coefficient of frictions with the second friction surfaces of the outer pressure plates 240, the third friction surfaces of the inner pressure plates 250, and/or other surfaces. By way of example, the insert discs 290 may be formed from copper, rubber, ceramic, or other materials with higher friction properties than steel. In other embodiments, the fifth friction surfaces of the insert discs 290 are coated with a coating (e.g., a copper coating, a ceramic coating, a rubber coating, a dry lubricant coating, etc.) formed from a material with high friction properties (e.g., copper, rubber, ceramic, dry lubricant, materials with a high surface roughness, materials with a low hardness, materials with higher friction properties than steel, etc.) so that the fifth friction surface may form a high coefficient of friction with the second friction surfaces of the outer pressure plates 240, the third friction surfaces of the inner pressure plates 250, and/or other surfaces.

According to the exemplary embodiment shown in FIG. 12, the outer pressure plates 240, the inner pressure plates 250, and the insert discs 290 are arranged in the slip gear assembly 200 such that the fifth friction surfaces of the insert discs 290 are in contact (e.g., direct contact, etc.) with at least one of the first friction surfaces of the inner body flange 236, the second friction surfaces of the outer pressure plates 240, the third friction surfaces of the inner pressure plates 250, or the fourth friction surface of the face plate 270 to form coefficient of frictions between (i) the fifth friction surfaces of the insert discs 290 and (ii) the first friction surfaces of the inner body flange 236, the second friction surfaces of the outer pressure plates 240, the third friction surfaces of the inner pressure plates 250, and the fourth friction surface of the face plate 270 that are in contact with the fifth friction surfaces of the insert discs 290. The friction between (i) the fifth friction surfaces of the insert discs 290 and (ii) the second friction surfaces of the outer pressure plates 240 and the third friction surfaces of the inner pressure plates 250 may allow for the outer pressure plates 240 to selectively couple with the inner pressure plates 250 when a load torque applied on the outer pressure plates 240 by the inner pressure plates 250 through the insert discs 290 is less than a first friction torque between the fifth friction surfaces of the insert discs 290 and the second friction surfaces of the outer pressure plates 240 and less than a second friction torque between the fifth friction surfaces of the insert discs 290 and the third friction surfaces of the inner pressure plates 250. When the load torque applied on the inner pressure plates 250 by the outer pressure plates 240 via the insert discs 290 exceeds either the first friction torque between the fifth friction surfaces of the insert discs 290 and the second friction surfaces of the outer pressure plates 240 or the second friction torque between the fifth friction surfaces of the insert discs 290 and the third friction surfaces of the inner pressure plates 250, the first friction torque or the second friction may be overcome and the outer pressure plates 240 may rotate relative to the inner pressure plates 250.

In some embodiments, the insert discs 290 are configured as wear components that wear throughout the operation of the vehicle 10. When operation of the slip gear assembly 200 has degraded due to the wear of the insert discs 290, the insert discs 290 may be replaced to increase the performance of the slip gear assembly 200 without replacing other components of the slip gear assembly 200 (e.g., the outer pressure plates 240, the inner pressure plates 250, etc.). Since the insert discs 290 are simpler components than the other components of the slip gear assembly 200 (e.g., formed out of a softer material, have less features, etc.), the insert discs 290 may make a process of refurbishing the slip gear assembly 200 easier.

### Modular Slip Gear Assembly

As shown in FIGS. 3 and 5-7, the slip gear assembly 200 is configured as a modular slip gear assembly that can be replaced by another modular slip gear assembly. By way of example, while operating the vehicle 10 in certain conditions (e.g., in a race, over jumps, etc.), performance of the slip gear assembly 200 may degrade (e.g., the outer pressure plates 240 and/or the inner pressure plates 250 may wear, the load threshold of the slip gear assembly 200 may decrease, etc.). By configuring the slip gear assembly 200 as the modular slip gear assembly, a first of the slip gear assemblies 200 may be replaced with a second of the slip gear assemblies 200 when the performance of the first of the slip gear assemblies 200 has degraded, allowing for the operational level of the vehicle 10 to be restored. By way of example, if the operator of the vehicle 10 determines that the performance of the slip gear assembly 200 has degraded during a race, the operator may replace the slip gear assembly 200 without removing the other components of the transmission assembly 100, allowing the operator to improve the performance of the vehicle 10 quickly and easily during or between race events. In order to remove the slip gear assembly 200 from the transmission assembly 100, the outer body fasteners 214 are removed from the outer body apertures 212 so that the slip gear assembly 200 can be slid off of an end of the drive shaft 160 to disengage the axle interface 232 from the gear interface 162 of the drive shaft 160. Another of the slip gear assemblies 200 can then be installed into the transmission assembly 100 by sliding the slip gear assembly 200 onto the end of the drive shaft 160 to engage the axle interface 232 with the gear interface 162 and insert the outer body fasteners 214 through the outer body apertures 212 to couple the slip gear assembly 200 to the bottom drive sprocket 140.

According to an exemplary embodiment, the slip gear assembly 200 is configured to couple to multiple different configurations of the bottom drive sprocket 140. By being able to couple to the multiple different configurations of the bottom drive sprocket 140, the gear ratio of the belt assembly 130 may be changed by changing the bottom drive sprocket 140 without changing the slip gear assembly 200. By way of example, the operator of the vehicle 10 may desire to change the gear ratio of the belt assembly 130 in order to adjust the performance of the vehicle 10 (e.g., increase a power provided to the front tractive assembly 58 and/or the rear tractive assembly 56, increase a speed of the front tractive assembly 58 and/or the rear tractive assembly 56, etc.). The operator of the vehicle 10 may exchange a first of the bottom drive sprockets 140 with a first number of teeth for a second of the bottom drive sprockets 140 with a second with a second number of teeth to change the gear ratio of the belt assembly 130. When the first of the bottom drive sprockets 140 and the second of the bottom drive sprockets 140 have the same pattern of the mounting apertures 147, the outer body apertures 212 of the slip gear outer body 210 of the slip gear assembly 200 may align with the mounting apertures 147 of either the first of the bottom drive sprockets 140 or the second of the bottom drive sprockets 140 to receive the outer body fasteners 214 to couple the slip gear outer body 210 to either the bottom drive sprockets 140 or the second of the bottom drive sprockets 140. As a result, the operator may utilize the slip gear assembly 200 with either the first of the bottom drive sprockets 140 or the second of the bottom drive sprockets 140 based on the desired gear ratio of the belt assembly 130.

In some embodiments, multiple different configurations of the slip gear assembly 200 is configured to be installed into the transmission assembly 100 to allow for changes in performance to the vehicle 10 without modifying the other components of the transmission assembly 100. By way of example, the operator of the vehicle 10 may desire a first of the slip gear assemblies 200 with a first load threshold during a cross-country race and a second of the slip gear assemblies 200 with a second load threshold during a snow-cross race (e.g., a race that includes jumps, etc.) that is lower than the first load threshold due to load spikes that are generated while landing a jump in the vehicle 10 under power. In order to achieve the desired load thresholds, the operator may install the first of the slip gear assemblies 200 with the first load threshold into the transmission assembly 100 during the cross-country race and may swap the first of the slip gear assemblies 200 with the second of the slip gear assemblies 200 during the snow-cross race. As a result, the operator may achieve the desired load thresholds without having to modify the other components of the transmission assembly 100 and/or use different of the vehicles 10 for the different races.

According to an exemplary embodiment, since the bottom drive sprocket 140 is a separate component (e.g., not integrally formed with, coupled to, etc.), the slip gear assembly 200, the bottom drive sprocket 140 and the slip gear outer body 210 may be formed from separate materials. In some embodiments, the bottom drive sprocket 140 is formed from a first material (e.g., a lightweight material, etc.) with a lower density than a second material used to form the slip gear outer body 210. By way of example, the slip gear outer body 210 may be formed out of steel (e.g., hardened steel, etc.) in order to accommodate the loads transferred between the slip gear outer body 210 and the outer pressure plates 240 and/or wear caused by other components of the slip gear assembly 200 while the bottom drive sprocket 140 may be formed out of aluminum since the loading and wear demands of the bottom drive sprocket 140 are lower. By forming the bottom drive sprocket 140 out of aluminum, a weight of the transmission assembly 100 may be decreased (e.g., compared to when the bottom drive sprocket 140 is formed out of steel, etc.), allowing for better performance (e.g., higher speeds, faster acceleration, etc.) of the vehicle 10. In various embodiments, since the slip gear assembly 200 limits limit loads transferred from the drive shaft 160 to the bottom drive sprocket 140, other components of the driveline 50 (e.g., components of the transmission assembly 100 positioned between the bottom drive sprocket 140 and the prime mover 52, components of the prime mover 52, etc.) are formed from lightweight materials (e.g., lighter than the material used to form the slip gear outer body 210, etc.) in order to decrease a weight of the vehicle 10.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 80, the vehicle controller 90, the transmission assembly 100, the slip gear assembly 200, etc.) as shown in the various exemplary embodiments is illustrative only. Additionally, any element disclosed in one embodiment may be incorporated or utilized with any other embodiment disclosed herein.

1. A slip gear assembly for transferring power between a prime mover and a tractive element of a snowmobile, the slip gear assembly comprising:
a first body configured to couple to a sprocket of the snowmobile coupled to the prime mover, the first body configured to rotate about an axis;
a second body configured to couple to a shaft of the snowmobile coupled to the tractive element, the second body configured to rotate about the axis;
one or more first pressure plates coupled to the first body and configured to rotate about the axis, the one or more first pressure plates comprising a first friction surface positioned on at least one side thereof; and
one or more second pressure plates coupled to the second body and configured to rotate about the axis, the one or more second pressure plates comprising a second friction surface positioned on at least one side thereof, the second friction surface forming a friction torque between the second friction surface and the first friction surface such that (a) the one or more second pressure plates are coupled to the one or more first pressure plates when a torque between the one or more first pressure plates and the one or more second pressure plates is less the friction torque and (b) the one or more second pressure plates and the one or more first pressure plates permit relative motion therebetween when the torque between the one or more first pressure plates and the one or more second pressure plates is greater than or equal to the friction torque.

2. The slip gear assembly of claim 1, wherein the slip gear assembly is configured as a dry slip gear assembly that does not include a fluid lubricant positioned between the first friction surface and the second friction surface.

3. The slip gear assembly of claim 1, wherein the first friction surface and the second friction surface extend perpendicular to the axis.

4. The slip gear assembly of claim 1, further comprising a spring configured to apply a force on the one or more first pressure plates and the one or more second pressure plates, the force oriented parallel to the axis.

5. The slip gear assembly of claim 4, wherein:
the spring is compressed between the first body and a first one of the one or more first pressure plates to apply the force on the one or more first pressure plates and the one or more second pressure plates; and
the slip gear assembly further comprises one or more shims positioned between the first body and the spring.

6. The slip gear assembly of claim 4, further comprising:
a retainer ring coupled to the first body, the retainer ring configured to hold the second body, the first pressure plate, the second pressure plate, and the spring in positions between the retainer ring and the first body.

7. The slip gear assembly of claim 6, wherein:
the one or more first pressure plates include a plurality of first pressure plates coupled to the first body;
the one or more second pressure plates include a plurality of second pressure plates coupled to the second body; and
the plurality of the first pressure plates and the plurality of the second pressure plates are arranged in an alternating pattern between the retainer ring and the spring.

8. The slip gear assembly of claim 1, wherein:
the first pressure plate and the second pressure plate are positioned between the first body and the second body; and
the first pressure plate and the second pressure plate are fluidly coupled to an environment surrounding the slip gear assembly.

9. The slip gear assembly of claim 1, further comprising:
an insert disc positioned between at least one of the one or more first pressure plates and at least one of the one or more second pressure plates, the insert disc comprising:
a first insert friction surface positioned on a first side of the insert disc, the first insert friction surface contacting the first friction surface of the at least one of the one or more first pressure plates to form a first insert friction torque, and
a second insert friction surface positioned on a second opposing side of the insert disc, the second insert friction surface contacting the second friction surface of the at least one of the one or more second pressure plates to form a second insert friction torque;
wherein the friction torque is equal to a lower of the first insert friction torque and the first insert friction torque.

10. The slip gear assembly of claim 1, wherein:
the first body is coupled to the one or more first pressure plates via a first spline connection; and
the second body is coupled to the one or more second pressure plate via a second spline connection.

11. The slip gear assembly of claim 1, further comprising the sprocket, wherein the first body is detachably coupled to the sprocket with a plurality of fasteners.

12. A vehicle comprising:
a frame;
a tractive assembly coupled to the frame;
a shaft coupled to the tractive assembly;
a prime mover configured to provide power to the tractive assembly to drive the tractive assembly; and
a transmission assembly configured to transfer the power from the prime mover to the tractive assembly, the transmission assembly comprising:
a belt assembly configured to receive the power from the prime mover, the belt assembly comprising:
a first sprocket configured to receive the power from the prime mover,
a second sprocket, and
a belt coupled to the first sprocket and the second sprocket, the belt configured to transfer the power between the first sprocket and the second sprocket; and
a slip gear assembly comprising:
a first body detachably coupled to the second sprocket,
a second body coupled to the shaft,
a first pressure plate coupled to the first body, and
a second pressure plate coupled to the second body, the second pressure plate contacting the first pressure plate to form a friction torque between the second pressure plate and the first pressure plate such that (a) the first pressure plate is coupled to the second pressure plate when a torque between the first pressure plate and the second pressure plate is less than the friction torque to allow for the power to be transferred from the prime mover to the tractive assembly and (b) the second pressure plate and the first pressure plate permit relative motion therebetween when the torque between the first pressure plate and the second pressure plate is greater than or equal to the friction torque.

13. The vehicle of claim 12, wherein the slip gear assembly is configured as a dry slip gear assembly that does not include a fluid lubricant therein.

14. The vehicle of claim 12, wherein the slip gear assembly further comprises a spring configured to apply a force on the first pressure plate and the second pressure plate.

15. The vehicle of claim 14, wherein the slip gear assembly further comprises a retainer ring coupled to the first body, the retainer ring configured to hold the second body, the first pressure plate, the second pressure plate, and the spring in positions between the retainer ring and the first body.

16. The vehicle of claim 12, wherein at least one of the first pressure plate or the second pressure plate includes a coating on at least one of a portion of the first pressure plate or a portion of the second pressure plate; and
wherein a coefficient of friction between the first pressure plate and the second pressure plate when the at least one of the first pressure plate or the second pressure plate includes the coating is higher than if the at least one of the first pressure plate or the second pressure plate do not include the coating.

17. The vehicle of claim 12, wherein:
the first body is coupled to the first pressure plate via a first spline connection; and
the second body is coupled to the second pressure plate via a second spline connection.

18. A transmission assembly for transmitting power between a prime mover and a tractive assembly of a snowmobile, the transmission assembly comprising:
a belt assembly configured to receive the power from the prime mover, the belt assembly comprising:
a first sprocket configured to receive the power from the prime mover,
a second sprocket, and
a belt coupled to the first sprocket and the second sprocket, the belt configured to transfer the power between the first sprocket and the second sprocket;
a shaft configured to provide the power to the tractive assembly; and
a slip gear assembly configured to transfer the power from the belt assembly to the shaft, the slip gear assembly comprising:
a first body removably coupled to the second sprocket,
a second body removably coupled to the shaft, the second body coupled to the first body when a torque between the first body and the second body is less than a torque threshold and the second body and the first body separately rotate when the torque between the first body and the second body is greater than or equal to the torque threshold.

19. The transmission assembly of claim 18, wherein:
the second sprocket defines a plurality of first apertures; and
the first body defines a plurality of second apertures configured to align with the plurality of first apertures to receive fasteners to couple the first body to the second sprocket.

20. The transmission assembly of claim 18, wherein:
the first body is formed from a first material; and
the second sprocket is formed from a second material with a lower density than the first material.
